(19) United States
(12) Patent Application Publication
(10) Pub. No.: US 2007/0223450 A1
(43) Pub. Date: Sep. 27, 2007

(54) Minimized setup time for IMS multimedia telephony using PRE provisioned resources reserve at answer

(75) Inventors: Jarl Tomas Holmstrom, Dalby (SE); Hans Krister Mikael Sallberg, Lund (SE); Peter Hedman, Helsingborg (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/275,382

(22) Filed: Dec. 29, 2005

Related U.S. Application Data
(60) Provisional application No. 60/718,845, filed on Sep. 20, 2005.

(51) Int. Cl. H04L 12/66

(52) U.S. Cl. 370/352

(57) ABSTRACT

Several different methods are described herein for reducing the setup time needed to establish a media flow (e.g., packet-based voice communications) between two devices (e.g., two GPRS UEs, GPRS UE/server, GPRS UE/WLAN UE). In one embodiment, the method minimizes the setup time for establishing IMS telephony using pre-provisioned resources—reserve at INVITE. In another embodiment, the method minimizes the setup time for establishing IMS telephony using pre-provisioned radio resources—reserve at ANSWER. In yet another embodiment, the method minimizes the setup time for establishing IMS telephony using pre-provisioned radio resources—reserve according to most demanding codec properties. All of these methods and in particular a UE and PS-CN may use the network initiated ISPCA method to reduce the setup time needed to assign packet-based bearers which are required to establish the media flow.

### CLAIMING BENEFIT OF PRIOR FILED PROVISIONAL APPLICATION

This application claims the benefit of U.S. Provisional Application Ser. No. 60/718,845 filed on Sep. 20, 2005 and entitled “Minimized Setup Times for the IMS Multimedia Telephony Service” which is incorporated by reference herein.

### CROSS REFERENCE TO RELATED APPLICATIONS

This application is related to the following patent applications:

1. U.S. patent application Ser. No. ______ filed on ______ and entitled “Minimized Setup Times for IMS Multimedia Telephony using Pre-Provisioned Resources—Reserve at INVITE” (Attorney Docket No. P21312) which is incorporated by reference herein.

2. U.S. patent application Ser. No. ______ filed on ______ and entitled “Implicit Secondary PDP Context Activation Method” (Attorney Docket No. P21343) which is incorporated by reference herein.

3. U.S. patent application Ser. No. ______ filed on ______ and entitled “Minimized Setup Times for IMS Multimedia Telephony using Pre-Provisioned Resources—Reserve According to Most Demanding Codec” (Attorney Docket No. P21346) which is incorporated by reference herein.

### BACKGROUND OF THE INVENTION

1. Field of the Invention

The present invention relates to a method for reducing the setup time needed to establish a media flow (e.g., packet-based voice communication) between two devices (e.g., two GPRS UEs, GPRS UE/server, GPRS UE/WLAN UE).

2. Description of Related Art

The following abbreviations are herewith defined, at least some of which are referred to in the ensuing description of the prior art and the preferred embodiments of the present invention.
3GPP Third Generation Partnership Project
AMR Adaptive Multi Rate
APN Access Point Name
CGI Cell Global Identification
GGSN Gateway GPRS Support Node
GPRS General Packet Radio Service
GMM GPRS Mobility Management
GTP GPRS Tunneling Protocol
IMS IP Multimedia Subsystem
ISPCA Implicit Secondary PDP Context Activation Procedure
LLC Logical Link Control
L-SAPI Logical Link Control Service Access Point Identifier
MM Mobility Management
N-SAPI Network Service Access Point Identifier
PCO Protocol Configuration Options
P-CSCF Proxy Call Session Control Function
PDP Packet Data Protocol
PS-CN Packet Switched Core Network including SGSN and GGSN
QoS Quality of Service
RAB Radio Access Bearer
RAN Radio Access Network
RB Radio Bearer
RFC Request for Comments
SDP Session Description Protocol
SGSN Serving GPRS Support Node
SIP Session Initiation Protocol
SM Session Management
TFT Traffic Flow Template
TI Transaction Identifier
TEID Tunnel Endpoint Identifier
UE User Equipment
WLAN Wireless Local Area Network

The 3GPP Rel-5 and later standards specify and define an IMS architecture along with a number of enablers that can be used to implement various multimedia services using packet-based bearers. For example, voice communication is one of these multimedia services that can be supported by the IMS architecture. Today, packet-based voice communication service in IMS can be realized but the quality of the service would not be comparable to the corresponding voice communication service that is built on a traditional circuit switched architecture. This problem is not addressed by the current 3GPP standards because the generic IMS signaling flows (e.g., registration, service activation) described therein are not optimized for specific IMS based applications like voice communications, video telephony, video-on-demand. A step-by-step description is provided next to show how an IMS Session is currently setup between two UEs.

Referring to FIG. 1 (PRIOR ART), there is a signal flow diagram illustrating the step-by-step process used to establish an IMS Session Setup flow in accordance to the principles in the current 3GPP release. The steps are as follows:
1. UE#1 and UE#2 perform GPRS attach (see 3GPP TS 23.060 section 6.5), activate PDP context for IMS signaling and register in IMS (see 3GPP TS 24.229 section B.2.2.1 and 5.1.1).
2. UE#1 sends P-CSCF#1 an INVITE which includes a ‘SDP offer’, a ‘media inactive/resources not met’, and a ‘service indicator=VoIMS (for example)’. The ‘media inactive . . . ’ indicates that UE#1 is not yet ready to send/receive the media and the radio resources are not considered as being available for the offered media.
3. The P-CSCF#1 in the originating network 102 forwards the INVITE to the P-CSCF#2 within the terminating network 104 (using normal SIP/IMS routing as described in TS 23.228 section 5.4a). The contents of TS23.228 are incorporated by reference herein.
4. The P-CSCF#2 in the terminating network 104 forwards the INVITE to UE#2.
5. The UE#2 should not alert its user until resources for the offered media are available. UE#2 responds to the INVITE by sending an SDP Answer (e.g. in a 183 or 200) to the P-CSCF#2. The SDP Answer includes a ‘media inactive/none’. The ‘media inactive/none’ indicates that UE#2 is not yet ready to send/receive the media and the radio resources are not considered as being available for the offered media.
6. The P-CSCF#2 in the terminating network 104 forwards the SDP Answer to the P-CSCF#1 in the originating network 102.
7. The P-CSCF#1 in the originating network 102 forwards the SDP Answer to UE#1.
8-12. UE#2 triggers the assignment of a media bearer by using the standardized UE initiated Secondary PDP Context Activation procedure (see TS 23.060 section 9.2.2.1.1). During this procedure there is SM signaling over the air interface between UE#2 and PS-CN#2 (see steps 8 and 12). And, there is lower level signaling between UE#2, RAN#2 (in GSM/EDGE this term is BSS see FIG. 3), and PS-CN#2 (this device can include a SGSN and GGSN as shown in FIGS. 2-3)(see steps 9-11).
The standardized UE initiated Secondary PDP Context Activation procedure is described in more detail below with respect to FIGS. 2 and 3 (PRIOR ART). At the completion of this procedure, the same context information is stored in UE#2 and PS-CN#2 (see TSS 23.060 sections 13.2-13.4).
13. The UE#1 acknowledges the 183/200 with an Ack. If the SDP Answer was carried in a 200 OK then the Ack is an ACK (according to RFC3261) otherwise the Ack is a PRACK.
14-18. UE#1 triggers the assignment of a media bearer by using the standardized UE initiated Secondary PDP Context Activation procedure (see TS 23.060 section 9.2.2.1.1). During this procedure there is SM signaling over the air interface between UE#1 and PS-CN#1 (see steps 14 and 18). And, there is lower level signaling between UE#1, RAN#1 (in GSM/EDGE this term is BSS see FIG. 3), and PS-CN#1 (this device can include a SGSN and GGSN as shown in FIGS. 2-3)(see steps 15-17).
Again, the standardized UE initiated Secondary PDP Context Activation procedure is described in detail below with respect to FIGS. 2 and 3 (PRIOR ART). At the completion of this procedure, the same context information is stored in UE#1 and PS-CN#1 (see TSS 23.060 sections 13.2-13.4).
19-20. The Ack from UE#1 (step 13) is forwarded to UE#2.
21-23. If the signal in steps 13 and 19-20 was a PRACK, then UE#2 acknowledges the PRACK with a 200 OK.
24. The UE#1 sends the P-CSCF#1 a re-INVITE. The re-INVITE includes a ‘SDP offer’, a ‘media active/resources are met’, and a ‘service indicator=VoIMS (for example)’. The ‘media active . . . ’ indicates that UE#1 is ready to send/receive the media and the radio resources are considered as being available for the offered media.
25. The P-CSCF#1 in the originating network forwards the re-INVITE to the P-CSCF#2 in the terminating network (using normal SIP/IMS routing as described in TS 23.228).
26. The P-CSCF#2 in the terminating network forwards the re-INVITE to UE#2.
27. The UE#2 at this point can alert its user. UE#2 responds to the re-INVITE by sending P-CSCF#2 a SDP Answer (e.g., in a 180 or 200) which includes a ‘media active/send recv/resources met’. The ‘media active/sendrecv/resources met’ indicates that the UE#2 expects to be given radio resources for the call and UE#2 starts listening on the ports announced in the SDP Answer.
28-29. The SDP Answer in 180/200 is forwarded to UE#1.
30-32. UE#1 acknowledges the SDP Answer.
33. The session setup continues as for normal IMS sessions (see 3GPP TS 23.228 v.6.10.0).

Referring to FIGS. 2-3 (PRIOR ART), there are two signal flow diagrams which are used to help explain the standardized UE initiated Secondary PDP Context Activation procedure relative to an Iu mode and an A/Gb mode (see steps 8-12 and 14-18 in FIG. 1). The TS 23.060 section 9.2.2.1.1 describes the standardized UE initiated Secondary PDP Context Activation procedure as follows:
The Secondary PDP Context Activation procedure may be used to activate a PDP context while reusing the PDP address and other PDP context information from an already active PDP context, but with a different QoS profile. Procedures for APN selection and PDP address negotiation are not executed. A unique TI and a unique NSAPI identifies each PDP context sharing the same PDP address and APN.
The Secondary PDP Context Activation procedure may be executed without providing a TFT to the newly activated PDP context if all other active PDP contexts for this PDP address and APN already have an associated TFT. Otherwise a TFT is provided. The TFT contains attributes that specify an IP header filter that is used to direct data packets received from the interconnected packet data network to the newly activated PDP context.
The Secondary PDP Context Activation procedure may only be initiated after a PDP context is already activated for the same PDP address and APN. The procedure is illustrated in FIGS. 2-3 (PRIOR ART).
1. The MS sends an Activate Secondary PDP Context Request (Linked TI, NSAPI, TI, QoS Requested, TFT, Protocol Configuration Options) message to the SGSN. Linked TI indicates the TI value assigned to any one of the already activated PDP contexts for this PDP address and APN. QoS Requested indicates the desired QoS profile. TFT is sent transparently through the SGSN to the GGSN to enable packet classification for downlink data transfer. TI and NSAPI contain values not used by any other activated PDP context. Protocol Configuration Options may be used to transfer optional PDP parameters and/or requests to the GGSN (see GSM 29.060 and GSM 24.229). Protocol Configuration Options are sent transparently through the SGSN.
2. In A/Gb mode, security functions may be executed (see TS 23.060 section 6.8).
3. The SGSN validates the Activate Secondary PDP Context Request using the TI indicated by Linked TI. The same GGSN address is used by the SGSN as for the already-activated PDP context(s) for that TI and PDP address.
The SGSN may restrict the requested QoS attributes given its capabilities and the current load, and it can restrict the requested QoS attributes according to the subscribed QoS profile, which represents the maximum QoS per PDP context to the associated APN. The GGSN may restrict and negotiate the requested QoS. The SGSN sends a Create PDP Context Request (QoS Negotiated, TEID, NSAPI, Primary NSAPI, TFT, Protocol Configuration Options, serving network identity, IMEISV, CGI/SAI, RAT type, S-CDR CAMEL information) message to the affected GGSN. The SGSN sends the serving network identity to the GGSN. Primary NSAPI indicates the NSAPI value assigned to any one of the already activated PDP contexts for this PDP address and APN. TFT is included only if received in the Activate Secondary PDP Context Request message. Protocol Configuration Options are sent transparently through the SGSN if received in the Activate secondary PDP Context Request message.
The GGSN uses the same packet data network as used by the already-activated PDP context(s) for that PDP address, generates a new entry in its PDP context table, and stores the TFT. The new entry allows the GGSN to route PDP PDUs via different GTP tunnels between the SGSN and the packet data network. The GGSN returns a Create PDP Context Response (TEID, QoS Negotiated, Cause, Protocol Configuration Options, Prohibit Payload Compression, APN Restriction) message to the SGSN. Protocol Configuration Options may be used to transfer optional PDP parameters to the UE (see GSM 29.060 and GSM 24.229). The Prohibit Payload Compression indicates that the SGSN should negotiate no data compression for this PDP context. If an APN Restriction is received from the GGSN for this PDP Context, then the SGSN stores this value for the PDP Context.
4. In Iu mode, RAB setup is done by the RAB Assignment procedure (see TS 23.060 section 12.7.4). This is the mode shown in FIG. 1.
5. In A/Gb mode, BSS packet flow context procedures may be executed. These procedures are defined in TS 23.060 clause “BSS Context”.
6. In case the QoS attributes have been downgraded in step 5 for A/Gb mode or in step 4 for Iu mode, the SGSN may inform the GGSN about the downgraded QoS attributes by sending an Update PDP Context Request to the affected GGSN. The GGSN confirms the new QoS attributes by sending an Update PDP Context Response to the SGSN.
7. The SGSN selects Radio Priority (Gb mode/GSM only) and Packet Flow Id based on QoS Negotiated, and returns an Activate Secondary PDP Context Accept (TI, QoS Negotiated, Radio Priority, Packet Flow Id, Protocol Configuration Options) message to the MS. If the MS indicated in the MS Network Capability does not support BSS packet flow procedures, then the SGSN should not include the Packet Flow Id. In A/Gb mode, the QoS Negotiated should take into account the Aggregate BSS QoS Profile, if any, returned from the BSS. Protocol Configuration Options are sent transparently through the SGSN if received in the Create PDP Context Response message. The SGSN is now able to route PDP PDUs between the GGSN and the MS via different GTP tunnels and possibly different LLC links.
For each additionally activated PDP context a QoS profile and TFT may be requested.
If the secondary PDP context activation procedure fails or if the SGSN returns an Activate Secondary PDP Context Reject (Cause, Protocol Configuration Options) message, the MS may attempt another activation with a different TFT, depending on the cause.

For a more detailed discussion about the traditional IMS session setup flow and the standardized UE initiated Secondary PDP Context Activation procedure, reference is made to the following documents:
3GPP TS 23.060 v.6.10.0 “General Packet Radio Service (GPRS) Service Description Stage 2 (Release 6)”, September 2005.
3GPP TS 23.228 v.6.10.0 “(IP Multimedia Subsystem (IMS) Stage 2 (Release 6), September 2005.
   The contents of these documents are incorporated by reference herein.

One reason for the long call setup time is due to the large amount of end-to-end signaling between UE#1 and UE#2 (see steps 2-7, 13, 19-32 in FIG. 1). As such, one aspect of the present invention relates to minimizing the end-to-end signaling between UE#1 and UE#2 to reduce the IMS Session Setup time. Another reason for the long call setup time is due to how the packet-based bearers are setup between UE#1/PS-CN#1 and UE#2/PS-CN#2 (see steps 8-12 and 14-18 in FIG. 1). The packet-based bearers are currently setup when a UE initiates a standardized Secondary PDP Context Activation Procedure (see FIGS. 2 and 3). And, during this procedure there is SM signaling over an air interface between UE and PS-CN (see steps 1 and 7 in FIGS. 2 and 3). It is another aspect of the present invention to reduce and possibly eliminate this SM signaling to further decrease the setup time needed to establish the packet-based bearers which in turn reduces the IMS Session Setup time. These needs and other needs are satisfied by the present invention.

### BRIEF DESCRIPTION OF THE INVENTION

The present invention discloses several different methods that can be used to reduce the setup time needed to establish a media flow (e.g., packet-based voice communications) between two devices (e.g., two GPRS UEs, GPRS UE/server, GPRS UE/WLAN UE). In one embodiment, the method minimizes the setup time for establishing IMS telephony using pre-provisioned resources—reserve at INVITE. In another embodiment, the method minimizes the setup time for establishing IMS telephony using pre-provisioned radio resources—reserve at ANSWER. In yet another embodiment, the method minimizes the setup time for establishing IMS telephony using pre-provisioned radio resources—reserve according to most demanding codec. In all of these methods, a UE and a PS-CN may use the new network initiated ISPCA method to reduce the setup time needed to assign packet-based bearers which are required to establish the media flow.

### BRIEF DESCRIPTION OF THE DRAWINGS

A more complete understanding of the present invention may be had by reference to the following detailed description when taken in conjunction with the accompanying drawings wherein:

FIG. 1 (PRIOR ART) is a signal flow diagram illustrating a step-by-step process used to establish an IMS Session Setup flow in accordance with the current 3GPP standards;

FIG. 2 (PRIOR ART) is a signal flow diagram illustrating an UE initiated Secondary PDP Context Activation Procedure for Iu mode as described within the current 3GPP standards;

FIG. 3 (PRIOR ART) is a signal flow diagram illustrating an UE initiated Secondary PDP Context Activation Procedure for A/Gb mode as described within the current 3GPP standards;

FIG. 4 is a signal flow diagram illustrating the network initiated ISPCA method for the A/Gb mode in accordance with the present invention;

FIG. 5 is a step-by-step flow diagram illustrating a network initiated ISPCA method for the Iu mode in accordance with the present invention;

FIG. 6 is a step-by-step flow diagram illustrating a network initiated Secondary PDP Context Activation Procedure in accordance with the present invention;

FIG. 7A is a step-by-step flow diagram used to help describe a method that can be used to establish a media flow between two GPRS UEs in accordance with a first embodiment of the present invention;

FIG. 7B is a step-by-step flow diagram used to help describe a method that can be used to establish a media flow between a GPRS UE and a server in accordance with the first embodiment of the present invention;

FIG. 7C is a step-by-step flow diagram used to help describe a method that can be used to establish a media flow between a GPRS UE and a WLAN UE in accordance with the first embodiment of the present invention;

FIGS. 8A and 8B are step-by-step flow diagrams used to help describe a method that can be used to establish a media flow between two GPRS UEs in accordance with a second embodiment of the present invention;

FIG. 9 is a step-by-step flow diagram used to help describe a method that can be used to establish a media flow between two GPRS UEs in accordance with a third embodiment of the present invention; and

FIG. 10 is a step-by-step flow diagram used to help describe a method that can be used to establish a media flow between two GPRS UEs in accordance with a fourth embodiment of the present invention.

### DETAILED DESCRIPTION OF THE DRAWINGS

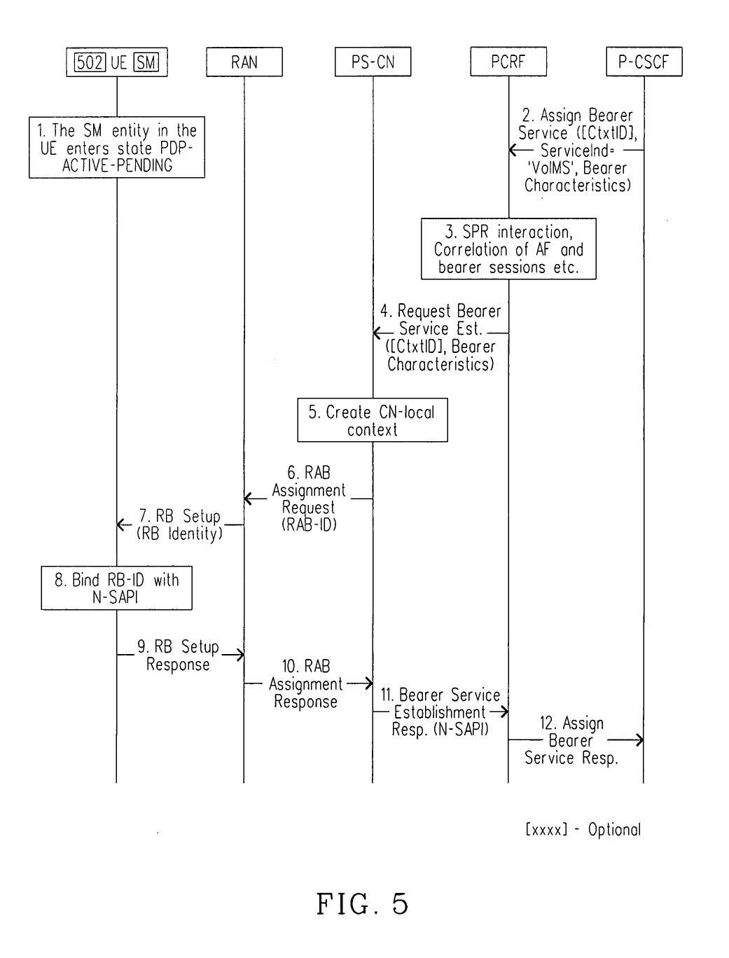

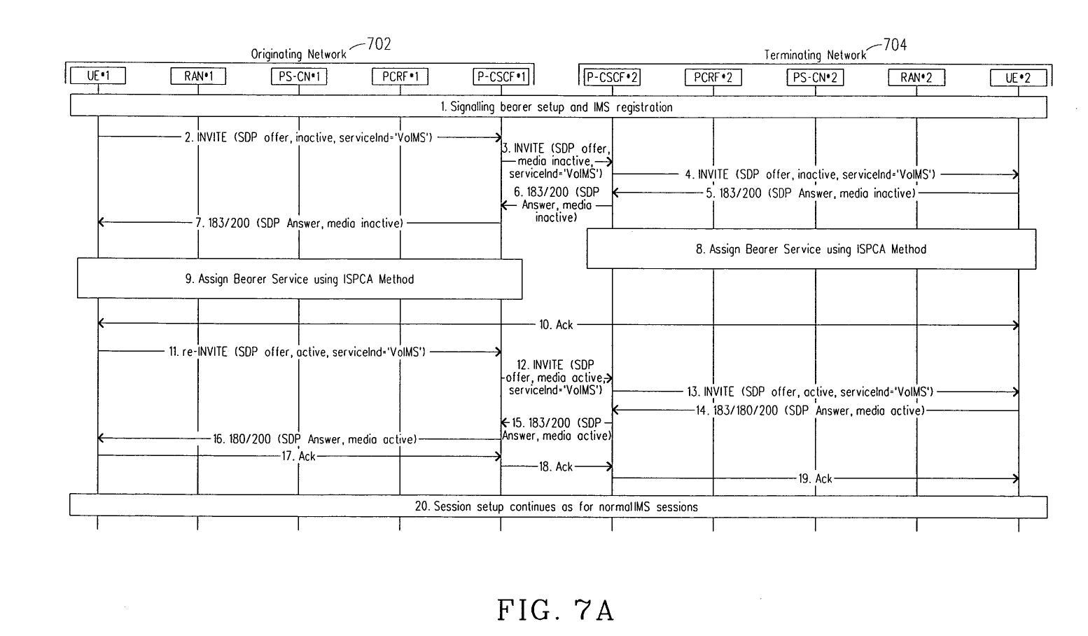

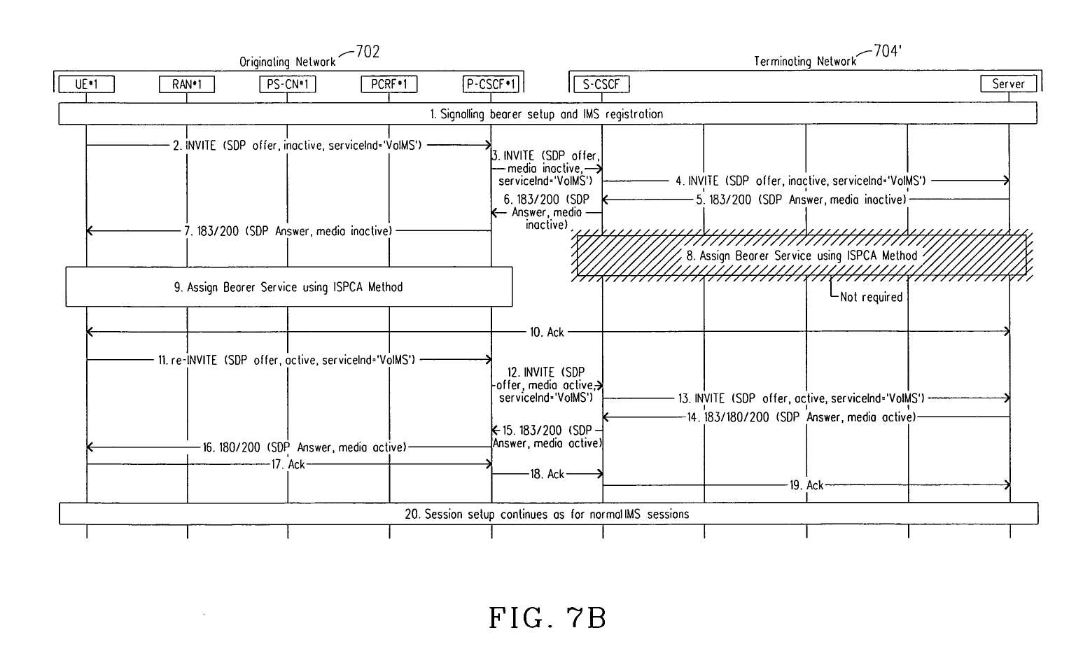

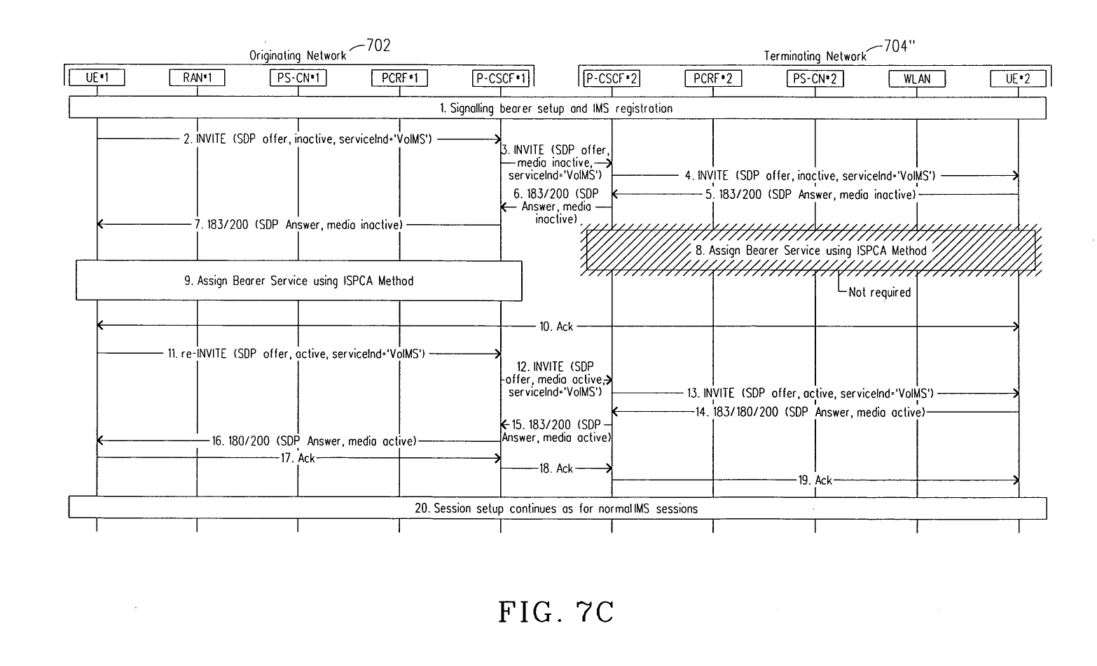

The present invention is directed to reducing the time needed to establish an IMS Session and there are several ways this can be done. First, the present invention introduces the network initiated ISPCA procedure that reduces/eliminates SM signaling over an air interface between a UE and a PS-CN when assigning packet-based bearers (radio resources) to the UE and PS-CN. Second, the present invention introduces several different methods that can be used to minimize end-to-end signaling between two devices (e.g., two GPRS UEs, GPRS UE/server, GPRS UE/WLAN UE) which in turn reduces the time needed to establish an IMS Session. These different methods may implement the network initiated ISPCA procedure or they may implement a network initiated Secondary PDP Context Activation Procedure or the existing UE initiated Secondary PDP Context Activation Procedure. To help describe the different aspects of the present invention the ISPCA method is described first with respect to FIGS. 4-5. Then, the network initiated Secondary PDP Context Activation Procedure is described with respect to FIG. 6. And, then the methods for reducing the setup time needed to establish a media flow between two UEs are described with respect to FIGS. 7-10.

The ISPCA Method

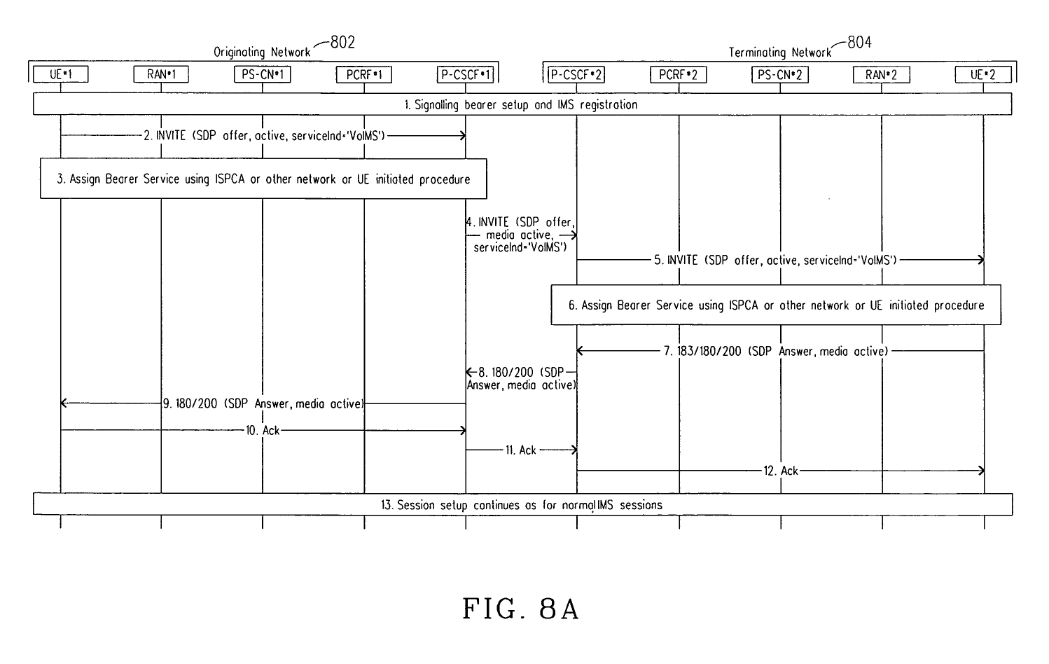

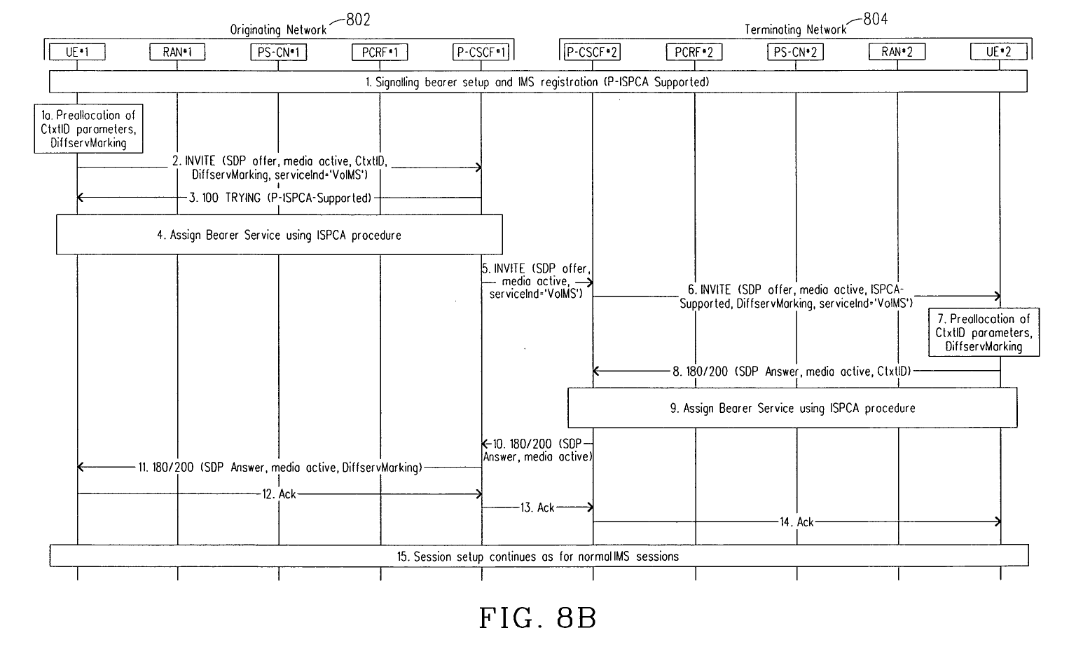

The ISPCA method reduces the setup time needed to assign packet-based bearers which are required to establish a media flow between UEs by reducing and possibly eliminating the SM signaling over an air-interface between a UE and a PS-CN. To accomplish this, the ISPCA method enables a UE and a PS-CN to locally activate/create their own media PDP context. A main feature of the ISPCA method is that instead of exchanging PDP context information (CtxtID) parameters in SM signaling as is done in the prior art all or a portion of this context information can be: (1) piggy-backed in application level signaling (requires changes in current SIP/SDP IETF standard—see FIG. 8B); (2) pre-defined in 3GPP standard (requires changes in current 3GPP standard—see FIGS. 7A-7C, 8A, 9 and 10); or (3) mixed predefined/piggy-backed (see discussion in FIG. 8B). The ISPCA method is depicted in FIG. 4 for A/Gb-mode and FIG. 5 for Iu-mode.

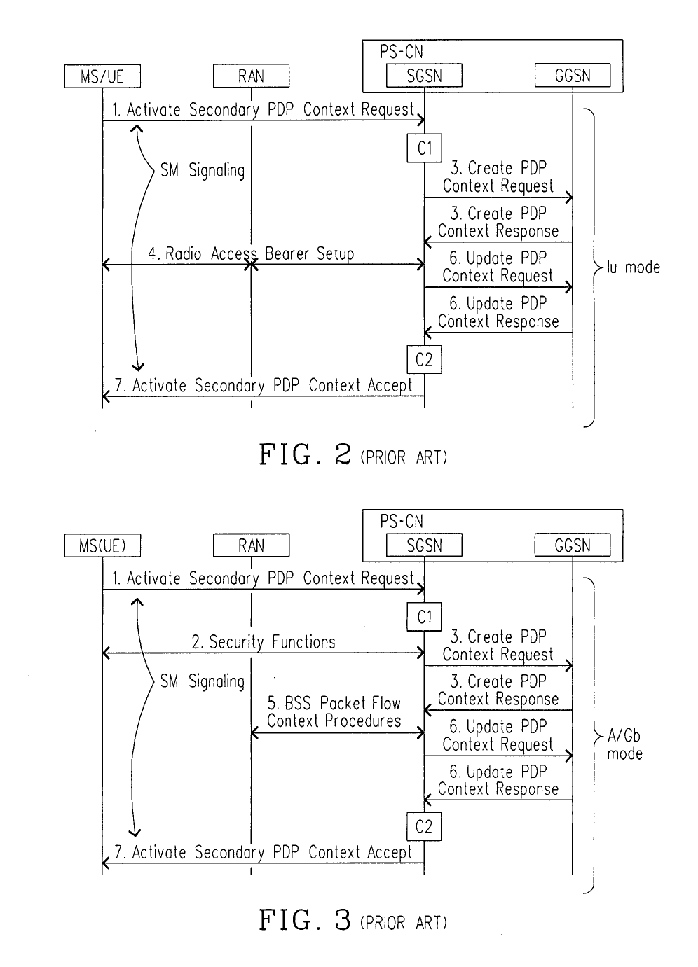

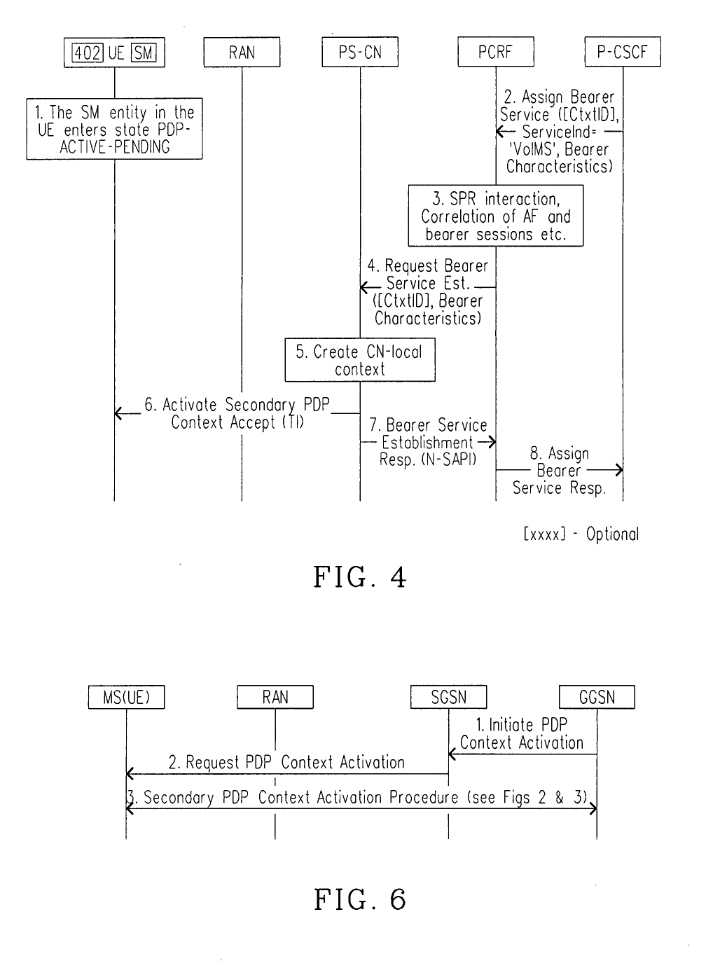

Referring to FIG. 4, there is a step-by-step flow diagram illustrating the ISPCA method for the A/Gb mode in accordance with one embodiment of the present invention. The steps are as follows:
1. The UE (which includes a processor 402) has a SM entity that enters state PDP-ACTIVE-PENDING as soon as it becomes aware that the implicit context activation is to be initiated. For example, the implicit context activation can be triggered by application level signaling or by the reception of an Activate Secondary PDP Context Accept message (see step 6).
2. The P-CSCF determines, based on application level signaling, that a PDP context for a VoIMS call (for example) needs to be set up and triggers the assignment of a media bearer by sending an AssignBearerService message (the name of this message name is subject to change) to the PCRF indicating ServiceInd=‘VoIMS’ (for example). The message also indicates BearerCharacteristics (e.g. QoS required for the service and information needed to create a TFT). In addition, the message may include values for one or more of the CtxtID parameters—‘N-SAPI’, ‘L-SAPI’ and ‘TI’. These CtxtID parameters if present in this message could have been assigned by the UE and piggy-backed in application level signaling to the P-CSCF, or e.g. known by the P-CSCF through ServiceInd based lookup.
Note: the application level signaling mentioned in steps 1 and 2 are SIP messages which can include the SDP Offer/Answer when the ISPCA method is used to setup an IMS flow as is shown in FIG. 7A (for example). But, the ISPCA method is not limited to IMS applications.
3. The PCRF performs the correlation of signaling- and media bearers and policy control as described in TR 23.803 sections 4.1.2, 4.1.3 and 7.2 (step 5). The contents of TR 23.803 V.7.0.0 (September 2005) are incorporated by reference herein.
4. If allowed by the policy, the PCRF forwards the request to setup a media bearer by sending a RequestBearerServiceEstablishment message (the name of this message name is subject to change) to the PS-CN. This message includes the required bearer characteristics. This message may also indicate the piggy-backed values for one or more of the CtxtID parameters.
5. A media PDP context is created locally in the PS-CN. First, context information is copied from the previously activated linked PDP Context (see TS 23.060 section 9.2.2.1). The copied context information includes a PDP Type, a PDP Address and an Access Point Name etc. . . . This step is also performed in the standardized Secondary PDP Context Activation Procedure (see FIGS. 2-3). In this step, the PS-CN builds the TFT based upon information in the ‘bearer characteristics’.
Secondly, the piggybacked and/or pre-defined values for the CtxtID parameters are added to the context information. The CtxtID parameters include ‘N-SAPI’, ‘L-SAPI’ and ‘TI’ and they can be: (1) assigned by the UE and piggybacked from the UE in the application level signaling (all or some); (2) pre-defined in a standard or by some other agreement (all or some); or (3) mixture of piggy-backed in application level signaling and pre-defined in a standard/agreement. The ‘ServiceInd’ could be used to indicate which pre-defined values should be used in the UE (MS) and PS-CN (SGSN/GGSN)(if any).
If the PS-CN happens to be a GPRS CN or Packet Switched CN that includes an SGSN and GGSN node, then a signaling message is sent from the GGSN to the SGSN. The message sent to the SGSN can contain the CtxtID parameters. For instance, the GGSN can send a PDU Notification Request message that contains the CtxtID parameters.
Moreover, the network can set the QoS requested (QoS_Req) based on the ‘BearerCharacterstics’. However, the QoS_Req could be set using anyone of a wide variety of ways. For instance, the QoS_Req can be set in a standard or it can be entirely dependent on a manufacturer.
6. The PS-CN sends an Activate Secondary PDP Context Accept message (via SM signaling) to the UE, indicating the TI value for the new context. The UE uses the indicated TI to identify which PDP context it has been allocated. In this case, the TI should be identical to the TI value allocated for the context activated through the procedure. If so, then the UE locally creates a PDP context (which is the same as the local context created by the PS-CN in step 5) and the SM entity in the UE enters state PDP-ACTIVE.
7. The PS-CN confirms the existence of a new bearer for the media by sending a BearerServiceEstablishmentResponse message to the PCRF which indicates the N-SAPI value for the activated context.
8. The PCRF replies by sending an AssignBearerServiceResponse message to the P-CSCF.

The message in step 6 (which was sent via SM signaling) is also used in the current 3GPP standard and is described above with respect to the standardized Secondary PDP Context Activation Procedure (see FIGS. 2-3). However, the messages in steps 2, 4, 7 and 8 are not used in the current 3GPP standard. As a result, the names of these messages will likely be different when the present invention becomes a standard. In conclusion, it can be seen that the ISPCA method effectively reduces the SM signaling over an air interface between the UE and PC-SN when compared to the standardized UE initiated Secondary PDP Context Activation Procedure described above with respect to FIGS. 2-3.

Referring to FIG. 5, there is a step-by-step flow diagram illustrating the ISPCA method for the Iu mode in accordance with another embodiment of the present invention. The steps are as follows:
1. The UE (which includes a processor 502) has a SM entity that enters state PDP-ACTIVE-PENDING as soon as it becomes aware that the implicit context activation is to be initiated. For example, the implicit context activation can be triggered by application level signaling or by the reception of a RB Setup Response message (see step 7).
2. The P-CSCF determines, based on application level signaling, that a PDP context for a VoIMS call (for example) needs to be set up and triggers the assignment of a media bearer by sending an AssignBearerService message (the name of this message name is subject to change) to the PCRF indicating ServiceInd=‘VoIMS’ (for example). The message also indicates BearerCharacteristics (e.g. QoS required for the service and information needed to create a TFT). In addition, the message may include values for one or more of the CtxtID parameters—‘N-SAPI’, ‘L-SAPI’ and ‘TI’. These CtxtID parameters if present in this message would have been assigned by the UE and piggy-backed in application level signaling to the P-CSCF, or e.g. known by the P-CSCF through ServiceInd based lookup.
Note: the application level signaling mentioned in steps 1 and 2 are SIP messages which can include the SDP Offer/Answer when the ISPCA method is used to setup an IMS flow as is shown in FIG. 7A (for example). But, the ISPCA method is not limited to IMS applications.
3. The PCRF performs the correlation of signaling- and media bearers and policy control as described in TR 23.803 sections 4.1.2. 4.1.3 and 7.2 (step 5). The contents of TR 23.803 V.7.0.0 (September 2005) are incorporated by reference herein.
4. If allowed by the policy, the PCRF forwards the request to setup a media bearer by sending a RequestBearerServiceEstablishment message (the name of this message name is subject to change) to the PS-CN. This message includes the required bearer characteristics. This message may also indicate the piggy-backed values for one or more of the CtxtID parameters.
5. A media PDP context is created locally in the PS-CN. First, context information is copied from the previously activated linked PDP Context (see TS 23.060 section 9.2.2.1). The copied context information includes a PDP Type, a PDP Address and an Access Point Name etc. . . . This step is also performed in the standardized Secondary PDP Context Activation Procedure (see FIGS. 2-3). In this step, the PS-CN builds the TFT based upon information in the ‘bearer characteristics’.
Secondly, the piggybacked and/or pre-defined values for the CtxtID parameters are added to the context information. The CtxtID parameters include ‘N-SAPI’, ‘L-SAPI’ and ‘TI’ and they can be: (1) assigned by the UE and piggybacked from the UE in the application level signaling (all or some); (2) pre-defined in a standard or by some other agreement (all or some); or (3) mixture of piggy-backed in application level signaling and pre-defined in a standard/agreement. The ‘ServiceInd’ could be used to indicate which pre-defined values should be used in the UE (MS) and PS-CN (SGSN/GGSN)(if any).
If the PS-CN happens to be a GPRS CN or Packet Switched CN that includes an SGSN and GGSN node, then a signaling message is sent from the GGSN to the SGSN. The message sent to the SGSN can contain the CtxtID parameters. For instance, the GGSN can send a PDU Notification Request message that contains the CtxtID parameters.
Moreover, the network can set the QoS requested (QoS_Req) based on the ‘BearerCharacterstics’. However, the QoS_Req could be set using anyone of a wide variety of ways. For instance, the QoS_Req can be set in a standard or it can be entirely dependent on a manufacturer.
6. The PS-CN triggers a RAB setup by sending a RAB Assignment Request message to the RAN. This message indicates a RAB-ID value equal to the N-SAPI value allocated for this PDP context.
7. The RAN sends a RB Setup message to the UE. This message indicates an RB Identity value equal to the N-SAPI value allocated for this PDP context.
8. The UE uses the indicated RB Identity to identify which context it has been allocated. In this case, the RB Identity should be identical to the N-SAPI value allocated for the context. If so, then the UE locally creates a PDP context (which is the same as the local context created by the PS-CN in step 5) and the SM entity in the UE enters state PDP-ACTIVE.
9. The UE sends a RB Setup Response message to the RAN.
10. The RAN sends a RAB Assignment Response message to the PS-CN.
11. The PS-CN confirms the existence of a new bearer for the media by sending a BearerServiceEstablishmentResponse message to the PCRF. This message indicates the N-SAPI value for the activated PDP context.
12. The PCRF sends an AssignBearerServiceResponse message to the P-CSCF.

The messages in steps 6, 7, 9 and 10 exist in the current 3GPP standard and are described in TS 23.060 section 9.2.2.1.1 and 12.7.4. However, the messages in steps 2, 4, 11 and 12 are not used in the current 3GPP standard. As a result, the names of these messages will likely be different when the present invention becomes a standard. In conclusion, it can be seen that the ISPCA method effectively eliminates the SM signaling over an air interface between the UE and PC-SN when compared to the standardized UE initiated Secondary PDP Context Activation Procedure (see FIGS. 2-3).

Network Initiated Secondary PDP Context Activation Procedure

The present invention can also use another network initiated procedure that can be implemented in the methods described below with respect to FIGS. 7-10. As shown in FIG. 6, this network initiated procedure is one in which a GGSN initiates the Secondary PDP Context Activation Procedure which was discussed in FIGS. 2-3 (see also TS 23.060 section 9.2.2.1.1). The steps are as follows:
1. The GGSN sends an Initiate PDP Context Activation message (which includes a TEID, NSAPI, QoS Requested, TFT and Protocol Configuration Options) to the SGSN. The QoS Requested, TFT, and Protocol Configuration Options are sent transparently through the SGSN.
2. The SGSN sends a Request PDP Context Activation message (which includes a TI, Linked TI, QoS Requested, TFT and Protocol Configuration Options) to the MS/UE. The Linked TI indicates the TI value assigned to the Activated PDP Context corresponding to the TEID and NSAPI described in step 1 above.
3. The MS/UE initiates the Secondary PDP Context activation procedure as described in FIGS. 2-3 and TS 23.0600 section 9.2.2.1.1. The Linked TI, TI, QoS Requested, TFT, and Protocol Configuration Options sent in the Activate secondary PDP Context Request are the same as described in step 2 above.

It should be noted that the Secondary PDP Context Activation Procedure shown in FIGS. 2 and 3 is initiated by the UE. Whereas, in the present invention this Secondary PDP Context Activation Procedure is initiated by the network.

### 1ST EMBODIMENT

### Reducing IMS Setup Time

FIG. 7A is a step-by-step flow diagram used to help describe a method that can be used to establish a media flow between two GPRS UEs (a GPRS UE is a terminal/device that supports packet data service e.g., GSM/WCDMA) in accordance with a first embodiment of the present invention. In this embodiment, UE#1 initially indicates that resources are not reserved in the SIP INVITE message (see step 1). And, then the originating network 702 initiates the resource reservation so the media flow can be established between UE#1 and UE#2. The steps in this flow are as follows:
1. UE#1 and UE#2 perform GPRS attach (see 3GPP TS 23.060 section 6.5), activate PDP context for IMS signaling and register in IMS (see 3GPP TS 24.229 section B.2.2.1 and 5.1.1).
2. UE#1 sends P-CSCF#1 an INVITE which includes a ‘SDP offer’, a ‘media inactive/resources not met’, and a ‘service indicator=VoIMS (for example)’. The ‘media inactive . . . ’ indicates that UE#1 is not yet ready to send/receive the media and the radio resources are not considered as being available for the offered media.
3. The P-CSCF#1 in the originating network 702 forwards the INVITE to the P-CSCF#2 within the terminating network 704 (using normal SIP/IMS routing as described in TS 23.228 section 5.4a).
4. The P-CSCF#2 in the terminating network 104 forwards the INVITE to UE#2.
5. The UE#2 should not alert its user until resources for the offered media are available. UE#2 responds to the INVITE by sending an SDP Answer (e.g. in a 183 or 200) to the P-CSCF#2. The SDP Answer includes a ‘media inactive/none’. The ‘media inactive/none’ indicates that UE#2 is not yet ready to send/receive the media and the radio resources are not considered as being available for the offered media.
6. The P-CSCF#2 in the terminating network 704 forwards the SDP Answer to the P-CSCF#1 in the originating network 702.
7. The P-CSCF#1 in the originating network 702 forwards the SDP Answer to UE#1.
8. The P-CSCF#2 in the terminating network 704 triggers the assignment of a media bearer within UE#2 and PS-CN#2 using the ISPCA method based on either the Iu mode or the A/Gb mode as described above with respect to FIGS. 4 and 5. In this flow, the context information parameters were assumed to be pre-defined in the 3GPP standard.
9. The P-CSCF#1 in the originating network 702 triggers the assignment of a media bearer within UE#1 and PS-CN#1 by using the ISPCA method based on either the Iu mode or the A/Gb mode as described above with respect to FIGS. 4 and 5. In this flow, the context information parameters were assumed to be pre-defined in the 3GPP standard.
It should be noted that UE#2/PS-CN#2 (or UE#1/PS-CN#1) does not need to use the ISPCA method and instead could use the network initiated Secondary PDP Context Activation Procedure (see FIG. 6). However, if UE#2/PS-CN#2 (or UE#1/PS-CN#1) does not use the ISPCA method then the IMS setup time will not be as short as it would be if both UE#1/PS-CN#1 and UE#2/PS-CN#2 used the ISPCA method.
10. The UE#1 acknowledges the 183/200 with a PRACK or ACK. And, UE#2 acknowledges the PRACK with a 200. If UE#1 received the bearer setup before this point in time, then the PRACK could also include a new SDP Offer which indicates that resources are available.
11. If the UE#1 receives the bearer setup after it has sent PRACK, then UE#1 sends a re-INVITE with a new SDP offer to indicate that the resources now are available.
12. The P-CSCF#1 in the originating network 702 forwards the re-INVITE to the P-CSCF#2 in the terminating network 704 (using normal SIP/IMS routing as described in TS 23.228).
13. The P-CSCF#2 in the terminating network 704 forwards the re-INVITE to UE#2.
14. The UE#2 can at this point alert its user. UE#2 responds to the re-INVITE by sending the P-CSCF#2 an SDP Answer (e.g. in a 180 or 200) which includes ‘media active/sendrecv/resources met’. The ‘media active/sendrecv/resources met’ indicates that the UE#2 expects to be given radio resources for the call and UE#2 starts listening on the ports announced in the SDP Answer.
15-16. The SDP Answer in 180/200 is forwarded to UE#1.
17-19. UE#1 acknowledges the SDP Answer.
20. The session setup continues as for normal IMS sessions (see 3GPP TS 23.228 v.6.10.0).

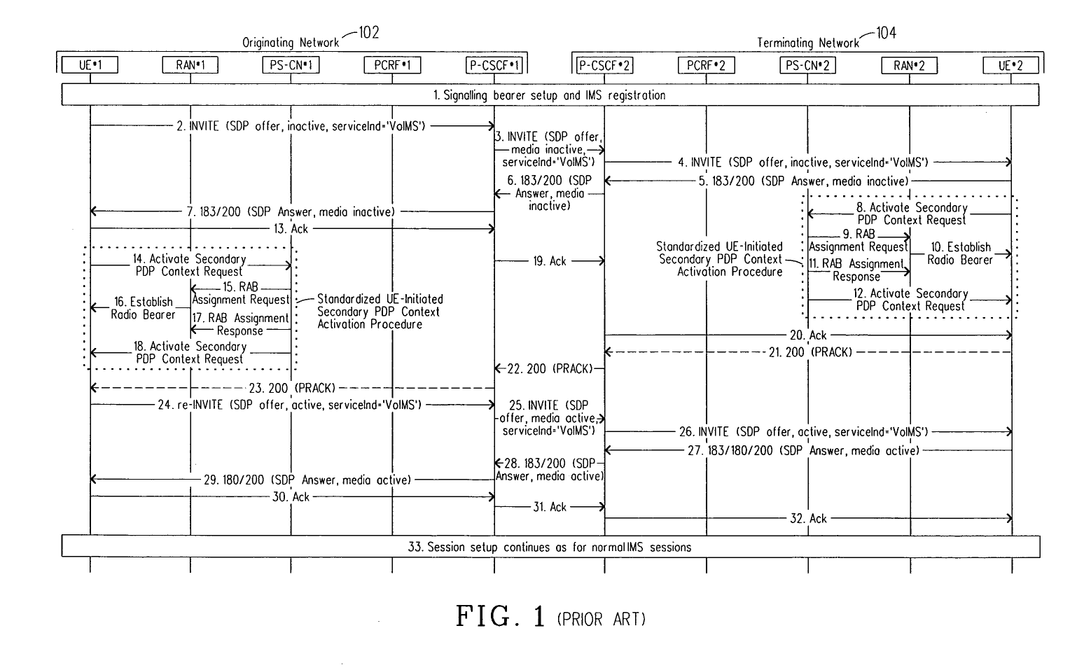

This IMS Session Setup flow takes place faster than the one shown in FIG. 1, because UE#1/PS-CN#1 and UE#2/PS-CN#2 utilize the network initiated ISPCA method to locally activate the PDP context which reduces/eliminates the SM signaling during steps 8 and 9. In addition, this IMS Session Setup flow takes place faster because steps 5/8, and 7/9 are each performed in parallel rather than in sequence as in FIG. 1. However, for this to happen each network 702 and 704 must know whether their corresponding UE#1 and UE#2 supports the network-initiated ISPCA method (or the network initiated method of FIG. 6). And, each UE#1 and UE#2 must know whether their corresponding network 702 and 704 supports the network-initiated ISPCA method (or the network initiated method of FIG. 6).

In particular, the support of the network initiated ISPCA procedure (or the network initiated method of FIG. 6) needs to be known as soon as there is a possibility that such procedures could be used. In other words, the UE needs to know if it is expected to use the ‘traditional’ UE initiated procedure or should/could leave the activation to the network. And, the network needs to know if the UE expects the network to request the activation or if it will do it on its own initiative. It is important that both the UE and network know what is expected of them and what they can expect. Because, if this information is not known, then the UE and network might try to activate one context each for the same media flow, Or, the UE and network might both be waiting (in vane) for the other side to start. Examples of how the UE and network can be informed about whether or not the other supports the network initiated ISPCA procedure (or the network initiated procedure of FIG. 6) are provided next.

1. Support of the network initiated process can be learnt by using SIP/SDP signaling, e.g. SIP REGISTER or in the SIP INVITE, or by using access specific signaling e.g. GMM signaling for GPRS. For example:
The UE can inform the SGSN (PS-CN) during the GPRS Attach procedure that it has the network initiated capability and the SGSN can inform the UE if it supports the network initiated process.
During SIP Registration, the UE can tell the P-CSCF if it supports the network initiated process. And, then the P-CSCF can tell the UE if it supports the network initiated process.

2. Support of the network initiated process could also be indicated in the Protocol Configuration Options IE (PCO IE) when activating the initial PDP context for IMS signaling. In particular, the UE could indicate support in the initial Activate PDP Context Request message. And, the network could indicate support in the Activate PDP Context Accept message (see 3GPP TS 23.060 for a description of the PDP Context Activation Procedure).

3. The support of the network initiated process could also be indicated by the UE and network respectively in MM/GMM information elements. For example, the MS Classmark, MS network capability, Network feature support, PCO and MM/GMM info messages/information elements can be used. These messages/information elements are described in TS 24.008 (the contents of which are incorporated by reference herein) as follows:
MM information procedure (MM Info)—section 4.3.6.
MM information—section 9.2.15a.
GMM Information procedure (GMM Info)—section 4.7.12.
GMM Information—section 9.4.19.
Mobile Station Classmark 1 (MS CM1)—section 10.5.1.5.
Mobile Station Classmark 2 (MS CM2)—section 10.5.1.6.
Mobile Station Classmark 3 (MS CM3)—section 10.5.1.7.
MS network capability—section 10.5.5.12.
Network feature support—section 10.5.5.23.
Protocol configuration options (PCO)—section 10.5.6.3.

As indicated earlier, the present invention can be used to reduce the setup time needed to establish a media flow (e.g., video-on-demand communication) between a GPRS UE and a server. This GPRS UE/server scenario is shown in FIG. 7B which is the same as the UE/UE scenario shown FIG. 7A except for the following differences between the terminating networks 704 and 704′: (1) a S-CSCF is used instead of a P-CSCF#2; (2) a server (e.g., SIP application server) is used instead of a UE#2; (3) the PCRF#2, PS-CN#2 and RAN#2 are not used (assuming the server is not wireless); and (4) step 8 is not used by the server and the S-CSCF (assuming the server is not wireless).

Moreover, the present invention can be used to reduce the setup time needed to establish a media flow (e.g., packet-based voice communication) between GPRS UE and a WLAN UE (a WLAN UE is user equipment that does not use GPRS and does not uses packet data protocol context). This GPRS UE/WLAN UE scenario is shown in FIG. 7C which is the same as the UE/UE scenario shown FIG. 7A except for the following differences between the terminating networks 704 and 704″: (1) a WLAN is used instead of a RAN#2; and (2) step 8 is not used by the WLAN UE#2 and the P-CSCF#2.

### 2ND EMBODIMENT

### Reducing IMS Setup Time (Reserve at INVITE)

FIGS. 8A-8B illustrate two step-by-step flow diagrams which are used to help describe two different variations of a method that can be used to establish a media flow between two GPRS UEs in accordance with a second embodiment of the present invention. In this embodiment, the total end-to-end call setup signaling flow shown in FIG. 7A was looked at and then several improvements were made to reduce the setup time for an IMS voice call (for example). The setup time for an IMS voice call is reduced in this embodiment by minimizing the signaling over the air-interface and by minimizing the end-to-end signaling between the UEs. This is achieved by: (1) using the network initiated ISPCA procedure (or the network initiated procedure of FIG. 6); or (2) assuming that in most cases radio- and PS-CN resources for the voice communication service will be available in the network.

### Example #1 (FIG. 8A)

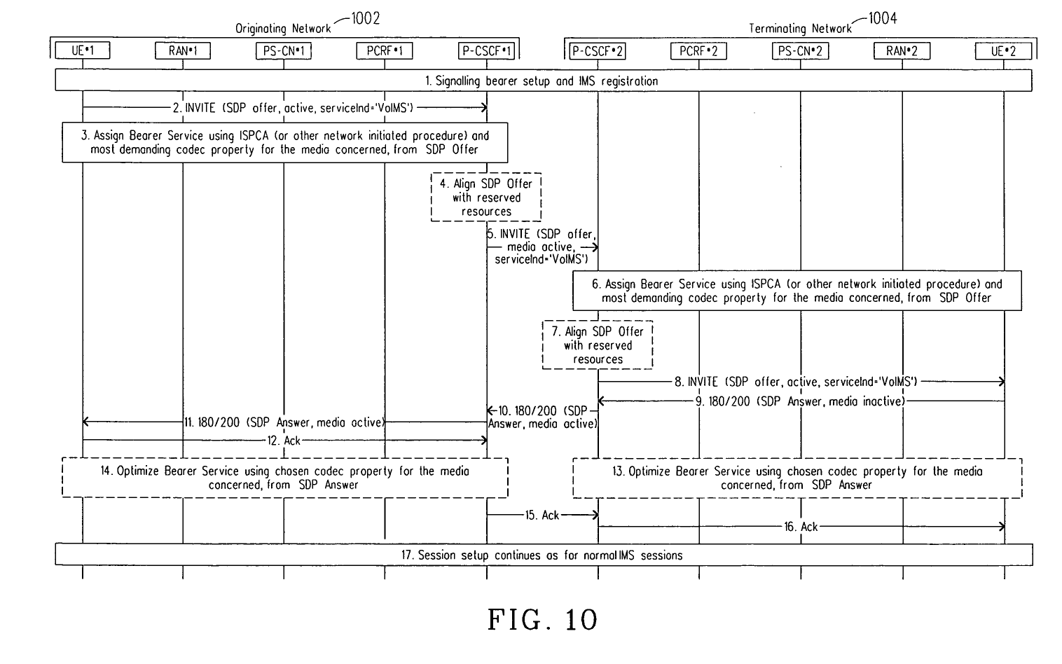

In example #1, the fixed values for the different CtxtID parameters used by the network initiated resource reservation are assumed to be standardized in 3GPP. And, the UEs and networks 802 and 804 support for the ISPCA procedure (or the network initiated procedure of FIG. 6) needs to be known in the system and this could be indicated in e.g. MS Classmark or MS network capability messages (see discussion in first embodiment for more options). The steps of example #1 are as follows:
1. UE#1 and UE#2 perform GPRS attach, activate contexts for IMS signaling, and register in IMS. The IMS registration may contain information about whether the network-initiated procedure is supported.
2. UE#1 sends the P-CSCF#1 an INVITE request which includes ‘SDP offer’, ‘media active/sendrecv/resources met’ and a ‘service indicator=VoIMS (for example)’. The ‘media active/sendrecv/resources met’ indicates that UE#1 expects to be given radio resources for the media and UE#1 starts listening on the ports announced in the SDP Offer.
Note: UE#1 has not actually reserved the radio resources for the media at this point. This is done in step 3.
3. The P-CSCF#1 triggers the assignment of a media bearer by using the network initiated ISPCA procedure or another network initiated procedure when sending the SIP INVITE request. If a network initiated procedure is not supported, then UE#1 can initiate the resource reservation directly when sending the SIP INVITE request.
It should be appreciated that the SDP Offer can include a number of codecs and codec properties/modes each of which may require different levels of QoS. The QoS could (if wanted) then be modified according to the appropriate QoS e.g. in step 13, or as in the fourth embodiment (see FIG. 10 steps 13 and 14). Alternatively, the codecs and codec properties included in the SDP Offer could result in a single defined bearer characteristic (QoS) suitable for all of them. But, to get efficient bearers, this would likely need to be standardized (e.g. indicate only one AMR mode in the initial SDP Offer).
4. The P-CSCF#1 in the originating network 802 forwards the INVITE to P-CSCF#2 in the terminating network 804 (using normal SIP/IMS routing as described in TS 23.228). The INVITE includes ‘SDP offer’, ‘media active/sendrecv/resources met’ and a ‘service indicator=VoIMS (for example)’. The ‘media active/sendrecv/resources met’ indicates that UE#1 is ready to send/receive the media and the radio resources are considered as available for the offered media.
The P-CSCF#1 could directly forward the SIP INVITE request. Or, the P-CSCF#1 could forward the SIP INVITE request after it receives input from PCRF#1 as to whether the radio resources are actually available and UE#1 is allowed to use the radio resources.
5. The P-CSCF#2 forwards the INVITE to UE#2. Again, the INVITE includes the ‘SDP offer’, ‘media active sendrecv/resources met’ and ‘service indicator=VoIMS (for example)’.
6. The P-CSCF#2 triggers the assignment of a media bearer by using the network initiated ISPCA procedure or another network initiated procedure when it sends the SIP INVITE request. If a network initiated procedure is not supported, then UE#2 could initiate the resource reservation directly upon receiving the SIP INVITE request.
7. The UE#2 can at this point alert the user. UE#2 sends P-CSCF#2 a SDP Answer (e.g. in a 180 or 200) which includes a ‘media active/sendrecv/resources met”. The ‘media active/sendrecv/resources met’ indicates that UE#2 expects to be given radio resources for the call and UE#2 starts listening on the ports announced in the SDP Answer.
8. The P-CSCF#2 in the terminating network 804 forwards the SDP Answer to the P-CSCF#1 in the originating network 802.
9. The P-CSCF#1 in the originating network 802 forwards the SDP Answer to UE#1.
10-12. UE#1 acknowledges the SDP Answer.
13. The session setup continues as for normal IMS sessions (see 3GPP TS 23.228 v.6.10.0).

In example #1, the fixed values for one or more of the different CtxtID parameters required for the network initiated resource reservation were assumed to be standardized in 3GPP for the different voice/video components of the multimedia flow. This is the pre-defined option described above with respect to the ISPCA method. If the CtxtID values are not standardized in 3GPP, then they could be standardized in IETF and transferred in SIP/SDP application level signaling. This is the piggy-backed application level signaling option described above with respect to the ISPCA method (see also example #2).

As indicated earlier, the present invention can be used to reduce the setup time needed to establish a media flow (e.g., video-on-demand communication) between a GPRS UE and a server. The GPRS UE/server scenario in this embodiment would be implemented in the same manner as the UE/UE scenario shown in FIG. 8A except for the following differences in the terminating network 804: (1) a S-CSCF is used instead of a P-CSCF#2; (2) a server (e.g., SIP application server) is used instead of a UE#2; (3) the PCRF#2, PS-CN#2 and RAN#2 are not used (assuming the server is not wireless); and (4) step 6 is not used by the server and the S-CSCF (assuming the server is not wireless).

Moreover, the present invention can be used to reduce the setup time needed to establish a media flow (e.g., packet-based voice communication) between GPRS UE and a WLAN UE. The GPRS UE/WLAN UE scenario in this embodiment would be implemented in the same manner as the UE/UE scenario shown in FIG. 8A except for the following differences in the terminating network 804: (1) a WLAN is used instead of a RAN#2; and (2) step 6 is not used by the WLAN UE#2 and the P-CSCF#2.

### Example #2 (FIG. 8B)

In example #2, it is assumed that ISPCA method is used but it is not possible to pre-define the CtxtID parameters in 3GPP. As such, in this example the CtxtID parameters and other parameters in example #2 are assumed to be standardized in IETF and then piggy-backed in SIP/SDP application level signaling. These parameters include:
ISPCA supported in SIP (e.g. sent to the UE during IMS registration or at the setup of the session).
a: N-SAPI per m-line in SDP.
a: TI per m-line in SDP.
a: L-SAPI per m-line in SDP.
a: Diffserv Marking per m-line in SDP and possibly other TFT information (not shown).

An advantage of adding the CtxtID parameters to SIP/SDP is that fewer values need to be pre-defined and that the ISPCA procedure can be easily used for any media component of the SDP.

In FIG. 8B, it is assumed the bearer characteristics for the media to be used are well-known and it also assumed that an optimized bearer can be reserved already when a P-CSCF receives the SIP INVITE request from a UE. The steps of example #2 are as follows:
1. UE#1 and UE#2 perform GPRS attach, activate contexts for IMS signaling, and register in IMS.
1a. UE#1 allocates the CtxtID parameters and DiffservMarkings.
2. UE#1 sends an INVITE request to the P-CSCF#1. The INVITE request includes ‘SDP offer’, ‘media active/sendrecv/resources met’, ‘CtxtID parameters’ and a ‘service indicator=VoIMS (for example). The ‘media active/sendrecv/resources met’ indicates that UE#1 expects to be given radio resources for the media and UE#1 starts listening on the ports announced in the SDP Offer.
Note: UE#1 has not actually reserved the radio resources for the media at this point. This is done in step 4.
3. The P-CSCF#1 responds with a 100 TRYING. If P-CSCF#1 supports the ISPCA method, then the P-CSCF#1 can indicate this support by including the P-header ‘P-ISPCA-Supported’. If P-CSCF#1 does not indicate support for the ISPCA method, then UE#1 should cancel the INVITE request and send a new INVITE request with media set to ‘inactive’.
4. The P-CSCF#1 triggers the assignment of a media bearer by using the ISPCA method as described in FIGS. 4 and 5.
5. The P-CSCF#1 in the originating network 802 forwards the INVITE to P-CSCF#2 in the terminating side 804 (using normal SIP/IMS routing as described in TS 23.228). The INVITE includes ‘SDP offer’, ‘media active/sendrecv/resources met’, ‘CtxtID parameters’ and a ‘service indicator=VoIMS (for example). The ‘media active/sendrecv/resources met’ indicates that UE#1 is ready to send/receive the media and radio resources are considered as being available for the offered media.
6. The P-CSCF#2 in the terminating network 804 forwards the INVITE to UE#2.
7. UE#2 allocates the CtxtID parameters and DiffservMarking.
8. The UE#2 can at this point alert the user. UE#2 sends the P-CSCF#2 an SDP Answer (e.g. in a 180 or 200) which includes ‘media active/sendrecv/resources met’ and ‘CtxtID’. The ‘media active/sendrecv/resources met’ indicates that the UE#2 expects to be given radio resources for the call and UE#2 starts listening on the ports announced in the SDP Answer.
Note: UE#2 has not actually reserved the radio resources for the media at this point. This is done in step 9.
9. The P-CSCF#2 in the terminating network 804 triggers the assignment of a media bearer by using the ISPCA method as described in FIGS. 4 and 5.
10. The P-CSCF#2 in the terminating network 804 forwards the SDP Answer to the P-CSCF#1 in the originating network 802.
11. The P-CSCF#1 in the originating network 802 forwards the SDP Answer to UE#1.
12-14. UE#1 acknowledges the SDP Answer.
15. The session setup continues as for normal IMS sessions (see 3GPP TS 23.228 v.6.10.0).

An advantage of this proposal which indicates the ‘media active/sendrecv/resources met’ in the initial SDP Offer is that it reduces the session setup time compared to existing procedures. Only ½ RTT is required between the two UEs before media or ringing may occur at the terminating UE#2.

As indicated earlier, the present invention can be used to reduce the setup time needed to establish a media flow (e.g., video-on-demand communication) between a GPRS UE and a server. The GPRS UE/server scenario in this embodiment would be implemented in the same manner as the UE/UE scenario shown in FIG. 8B except for the following differences in the terminating network 804: (1) a S-CSCF is used instead of a P-CSCF#2; (2) a server (e.g., SIP application server) is used instead of a UE#2; (3) the PCRF#2, PS-CN#2 and RAN#2 are not used (assuming the server is not wireless); and (4) steps 7 and 9 are not used by the server and the S-CSCF (assuming the server is not wireless).

Moreover, the present invention can be used to reduce the setup time needed to establish a media flow (e.g., packet-based voice communication) between GPRS UE and a WLAN UE. The GPRS UE/WLAN UE scenario in this embodiment would be implemented in the same manner as the UE/UE scenario shown in FIG. 8B except for the following differences in the terminating network 804: (1) a WLAN is used instead of a RAN#2; and (2) steps 7 and 9 are not used by the WLAN UE#2 and the P-CSCF#2.

### 3RD EMBODIMENT

### Reducing IMS Setup Time (Reserve at Answer)

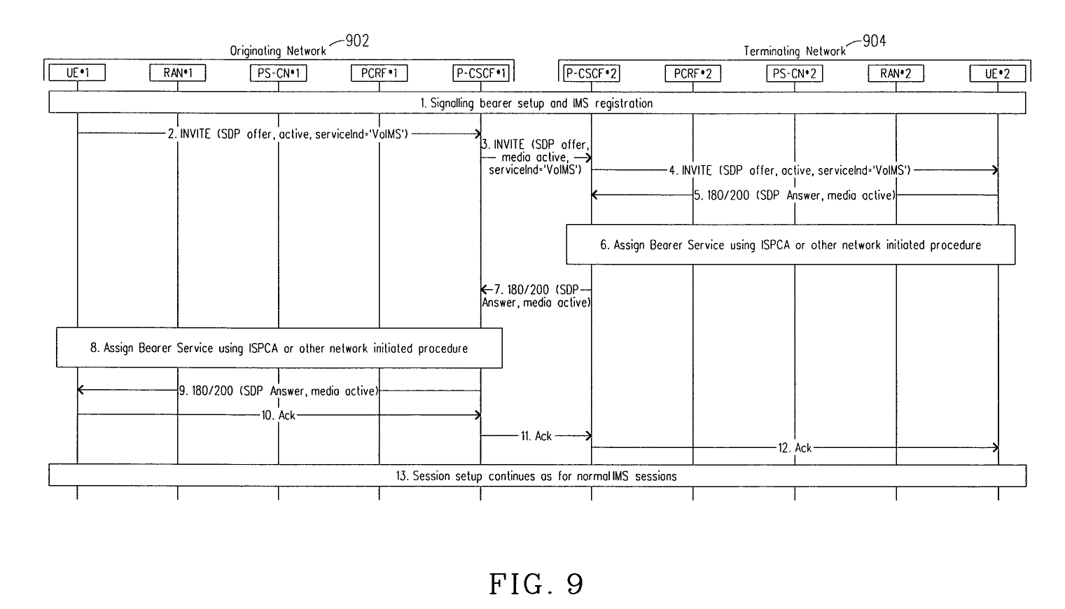

FIG. 9 illustrates a step-by-step flow diagram which is used to help describe a method that can be used to establish a media flow between two GPRS UEs in accordance with a third embodiment of the present invention. In this embodiment, the total end-to-end call setup signaling flow shown in FIG. 7A was looked at and then several improvements were made to reduce the setup time for an IMS voice call (for example). The setup time for an IMS voice call is reduced in this embodiment by minimizing the signaling over the air-interface and by minimizing the end-to-end signaling between the UEs. This is achieved by: (1) using the network initiated ISPCA procedure (or the network initiated procedure of FIG. 6); and (2) assuming that in most cases radio- and PS-CN resources for the voice communication service will be available in the network.

In this case, the UE (UE#1 and/or UE#2) indicates that radio resources have been reserved (even though they have not actually been reserved) by setting the appropriate attributes in the SDP body of a SIP INVITE request (see step 2 in FIG. 9) and/or a SIP INVITE response (see step 5 in FIG. 9). The radio resources are then actually reserved (or at least attempted to be reserved) when the SDP answer is known by the network to avoid unnecessary resource usage (see steps 6 and 8 in FIG. 9). This feature allows the SDP offer to contain multiple codec properties for each media component, e.g. voice. For example, UE#1's SDP Offer may contain multiple codecs AMR and AMR-WB for speech. When the SDP Offer is answered at the remote UE#2, the remote UE#2 would narrow down the alternatives to one codec and indicate this in the SDP Answer. Otherwise, UE#1 could send packets using codec AMR, and UE#2 could send packets using codec AMR-WB, i.e. encoder and decoder could be different. The steps for this flow are as follows:
1. UE#1 and UE#2 perform GPRS attach, activate contexts for IMS signaling, and register in IMS. The IMS registration may contain information that indicates whether the UE and network supports the network-initiated ISPCA procedure (or another network-initiated procedure like the one shown in FIG. 6).
2. UE#1 sends an INVITE request to P-CSCF#1. The INVITE includes ‘SDP offer’, ‘media active/sendrecv/resources met’ and a ‘service indicator=VoIMS (for example). The ‘media active/sendrecv/resources met’ indicates that UE#1 expects to be given radio resources for the media and UE#1 starts listening on the ports announced in the SDP Offer.
Note: UE#1 indicates that is has reserved the radio resources but at this point it has not actually reserved the radio resources. This is done in step 8.
Note: The SDP offer contains multiple codec alternatives for each media component.
3. The P-CSCF#1 in the originating network 902 forwards the INVITE to the P-CSCF#2 in the terminating network 904 (using normal SIP/IMS routing as described in TS 23.228). The INVITE includes a ‘SDP offer’, a ‘media active/sendrecv/resources met’, and a ‘service indicator=VoIMS (for example)’. The ‘media active/sendrecv/resources met’ indicates that UE#1 is ready to send/receive the media and radio resources are considered as available for the offered media.
4. The P-CSCF#2 in the terminating network 904 forwards the INVITE to UE#2. Again, the INVITE includes the ‘SDP offer’, ‘media active/sendrecv/resources met’, and ‘service indicator=VoIMS (for example)’.
5. The UE#2 may at this point alert the user. UE#2 responds to the P-CSCF#2 with an SDP Answer (e.g. in a 180 or 200) which includes a ‘media active/sendrecv/resources met’. The ‘media active/sendrecv/resources met’ indicates that UE#2 expects to be given radio resources for the call and UE#2 starts listening on the ports announced in the SDP Answer.
Note: UE#2 indicates that is has reserved the radio resources but at this point it has not actually reserved the radio resources. This is done in step 6.
6. The P-CSCF#2 in the terminating network 904 triggers the assignment of a media bearer by using the network initiated ISPCA procedure (see FIGS. 4-5) or another network initiated procedure (see FIG. 6). In this flow, the ISPCA method was used and the context information parameters were assumed to be pre-defined in the 3GPP standard.
7. The P-CSCF#2 in the terminating network 904 forwards the SDP Answer to the P-CSCF#1 in the originating network 902.
8. The P-CSCF#1 triggers the assignment of a media bearer by using the network initiated ISPCA procedure (see FIGS. 4-5) or another network initiated procedure (see FIG. 6). In this flow, the ISPCA method was used and the context information parameters were assumed to be pre-defined in the 3GPP standard.
9. The P-CSCF#1 in the originating network 902 forwards the SDP Answer to UE#1.
10-12. UE#1 acknowledges the SDP Answer.
13. The session setup continues as for normal IMS sessions (see 3GPP TS 23.228 v.6.10.0).

Some of the advantages of this session setup compared to the existing session setup shown in FIG. 1 are:
The radio resources are not reserved until it is known that UE#2 is available for the session, i.e. the bearer can be optimized for the agreed media and no resources are wasted for cases when the terminating user never answers the call.
It only requires a half end-to-end RTT delay before the ringing can start at the terminating UE.

As indicated earlier, the present invention can be used to reduce the setup time needed to establish a media flow (e.g., video-on-demand communication) between a GPRS UE and a server. The GPRS UE/server scenario in this embodiment would be implemented in the same manner as the UE/UE scenario shown in FIG. 9 except for the following differences in the terminating network 904: (1) a S-CSCF is used instead of a P-CSCF#2; (2) a server (e.g., SIP application server) is used instead of a UE#2; (3) the PCRF#2, PS-CN#2 and RAN#2 are not used (assuming the server is not wireless); and (4) step 6 is not used by the server and the S-CSCF (assuming the server is not wireless).

Moreover, the present invention can be used to reduce the setup time needed to establish a media flow (e.g., packet-based voice communication) between GPRS UE and a WLAN UE. The GPRS UE/WLAN UE scenario in this embodiment would be implemented in the same manner as the UE/UE scenario shown in FIG. 9 except for the following differences in the terminating network 904: (1) a WLAN is used instead of a RAN#2; and (2) step 6 is not used by the WLAN UE#2 and the P-CSCF#2.

### 4TH EMBODIMENT

### Reducing IMS Setup Time (Reserve Using Most Demanding Codec Properties)

FIG. 10 illustrates a step-by-step flow diagram which is used to help describe a method that can be used to establish a media flow between two GPRS UEs in accordance with a fourth embodiment of the present invention. In this embodiment, the total end-to-end call setup signaling flow shown in FIG. 7A was looked at and then several improvements were made to reduce the setup time for an IMS voice call (for example). The setup time for an IMS voice call is reduced in this embodiment by minimizing the signaling over the air-interface and by minimizing the end-to-end signaling between the UEs. This is achieved by: (1) using the network initiated ISPCA procedure (or the network initiated procedure of FIG. 6); or (2) assuming that in most cases radio- and PS-CN resources for the voice communication service will be available in the network.

In this case, the UE (UE#1) indicates that radio resources have been reserved (even though they have not actually been reserved) by setting the appropriate attributes in the SDP body of a SIP INVITE request (see step 2 in FIG. 10). The originating network 1002 then reserves resources according to the most demanding codec property for the corresponding media component (see step 3 in FIG. 10). And, when the originating network 1002 receives the SDP answer (in the SIP 183/180 or 200) from the terminating network 1004 then it can modify the bearer by choosing the most optimized bearer for the chosen codec property (see step 14 in FIG. 10). To avoid having the terminating network 1004 reserve too many resources the P-CSCF#1 could remove codec properties that cannot be used with the reserved resources (see step 4 in FIG. 10). The steps for this flow are as follows:
1. UE#1 and UE#2 perform GPRS attach, activate PDP context for IMS signaling, and register in IMS. The IMS registration may contain information that indicates whether the UE and network supports the network-initiated ISPCA procedure (or another network-initiated procedure like the one shown in FIG. 6).
2. UE#1 sends an INVITE request to P-CSCF#1. The INVITE includes a ‘SDP offer’, a ‘media active/sendrecv/resources met’, and a ‘service indicator=VoIMS (for example)’. The ‘media active/sendrecv/resources met’ indicates that UE#1 expects to be given radio resources for the media and UE#1 starts listening on the ports announced in the SDP Offer.
Note: UE#1 indicates that it has reserved the radio resources with the most demanding codec property for the media concerned but at this point it has not actually reserved the radio resources.
3. The P-CSCF#1 triggers the assignment of a media bearer by using the network initiated ISPCA procedure (see FIGS. 4-5) or another network initiated procedure (see FIG. 6). In this flow, the most demanding codec property is used as input to the bearer reservation.
Note: the ISPCA method was used in this flow and the context information parameters were assumed to be pre-defined in the 3GPP standard.
4. Optionally, the P-CSCF#1 may remove such codec properties from the SDP offer that would not work with the bearer that was actually reserved. If this step is not performed, then the P-CSCF#1 could directly forward the SIP INVITE request without waiting for the bearer reservation in step 3.
5. The P-CSCF#1 in the originating network 1002 forwards the INVITE to P-CSCF#2 in the terminating network (using normal SIP/IMS routing as described in TS 23.228). The INVITE includes the ‘SDP offer’, ‘media active/sendrecv/resources met’ and ‘service indicator=VoIMS (for example)’. The ‘media active/sendrecv/resources met’ indicates that UE#1 is ready to send/receive the media and the radio resources are considered as available for the offered media.
6. The P-CSCF#1 in the terminating network triggers the assignment of a media bearer by using the network initiated ISPCA procedure (see FIGS. 4-5) or another network initiated procedure (see FIG. 6). In this flow, the most demanding codec property is used as input to the bearer reservation.
Note: the ISPCA method was used in this flow and the context information parameters were assumed to be pre-defined in the 3GPP standard.
Note: the INVITE from step 4 could imply multiple codec alternatives some of which may or may not be possible to reserve within the terminating network 1004. In this case, the terminating network 1004 reserves the radio resources it can use before sending the SDP Offer to UE#2.
7. Optionally, the P-CSCF#2 may remove such codec properties from the SDP offer that would not work with the bearer that was actually reserved. If this step is not performed, then the P-CSCF#2 could directly forward the SIP INVITE request without waiting for the bearer reservation in step 6.
8. The P-CSCF#2 in the terminating network 1004 forwards the SIP INVITE request to UE#2. The INVITE includes the ‘SDP offer’, ‘media active sendrecv/resources met’, and ‘service indicator=VoIMS (for example)’.
9. The UE#2 may at this point alert the user. UE#2 responds to P-CSCF#2 with an SDP Answer (e.g. in a 180 or 200) which includes a ‘media active/send recv/resources met’. The ‘media active/send recv/resources met’ indicates that UE#2 expects to be given radio resources for the call and UE#2 starts listening on the ports announced in the SDP Answer.
10. The P-CSCF#2 in the terminating network 1004 forwards the SDP Answer to the P-CSCF#1 in the originating network 1002.
11. The P-CSCF#1 in the originating network 1002 forwards the SDP Answer to UE#1.
12, 15, 16. UE#1 acknowledges the SDP Answer.
13. 14. The P-CSCF#1 and P-CSCF#2 may each trigger the assignment of an optimized media bearer by using the ISPCA method. This is done to avoid using a bearer that is to expensive for the finally chosen media codec property.
For instance, if the codec property that required most resources was not finally chosen in the SDP Answer, then the resources reserved would be higher than required by the used codec. To save resources, it is then possible to modify the resources according to the codec property used. Again, this is a modification procedure. The same PDP context is still used.
17. The session setup continues as for normal IMS sessions (see 3GPP TS 23.228 v.6.10.0).

This flow decreases the IMS session setup time when compared to the existing flow shown in FIG. 1 even though the resource reservation and the forwarding of the SIP messages are not initially done in parallel (see steps 2&3 and 6&8). Some additional advantages of this session setup compared to the existing session setup shown in FIG. 1 are:
Avoids ghost ringing.
Only requires ½ E2E RTT before ringing and media transfer may start at UE#2 (compared to 1.5 RTT for current standardized flows, were UE reserves resources at reception of first SDP answer).
Multiple media properties for a media in the SDP Offer is allowed.

As indicated earlier, the present invention can be used to reduce the setup time needed to establish a media flow (e.g., video-on-demand communication) between a GPRS UE and a server. The GPRS UE/server scenario in this embodiment would be implemented in the same manner as the UE/UE scenario shown in FIG. 10 except for the following differences in the terminating network 1004: (1) a S-CSCF is used instead of a P-CSCF#2; (2) a server (e.g., SIP application server) is used instead of a UE#2; (3) the PCRF#2, PS-CN#2 and RAN#2 are not used (assuming the server is not wireless); and (4) steps 6, 7 and 13 are not used by the server and the S-CSCF (assuming the server is not wireless).

Moreover, the present invention can be used to reduce the setup time needed to establish a media flow (e.g., packet-based voice communication) between GPRS UE and a WLAN UE. The GPRS UE/WLAN UE scenario in this embodiment would be implemented in the same manner as the UE/UE scenario shown in FIG. 10 except for the following differences in the terminating network 1004: (1) a WLAN is used instead of a RAN#2; and (2) steps 6, 7 and 13 are not used by the WLAN UE#2 and the P-CSCF#2.

Following are some additional features and advantages associated with the present invention:
1. The present invention promotes the use of the IMS Multimedia Telephony service since the user experience in terms of call setup delay will be improved.
2. The present invention reduces the complexity of the signaling flows for the setup of the voice/video part of the IMS Multimedia Telephony Service.
3. Throughout the description “voice over IMS” was used as an example of a service, but it should be understood that the present invention can be used for other services such as video over IMS or video-on-demand.
4. The description provided herein about the UE, RAN, PS-CN, PCRF and P-CSCF etc. . . . omitted details that are well known in the industry and are not needed to understand the present invention. This was done for clarity.
5. The ISPCA method significantly reduces the setup time for establishing a media flow of e.g. IMS Multimedia Service or another Application Function. It does this by minimizing the amount of signaling over the air interface and minimizing the number of round trips of signaling.
6. The ISPCA method can also be used in more general applications instead of just IMS. For instance, it can be used to implement similar application functions between an UE and a network server which interfaces with a PCRF node, e.g. a Media streaming server, Video on demand server.

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A method for establishing a media flow between a first device and a second device, said method comprising the steps of:
sending, from said first device, a first message towards said second device, where the first message indicates that a first core network and said first device have reserved radio resources which includes a set of possible codecs for a particular media component that could be used to establish the media flow with said second device;
receiving, at said first device, a second message initiated by said second device, where the second message indicates that said second device has reserved radio resources including one of the possible codecs for the particular media component that will be used to establish the media flow with said first device; and
after receiving the second message, reserving the radio resources that said first device and said first core network will use to establish the media flow with said second device.

2. The method of claim 1, wherein said reserving step includes implementing a network initiated secondary packet data protocol context activation procedure which is used by said first device and said first core network to reserve the radio resources they will use to establish the media flow with said second device.

3. The method of claim 1, wherein said reserving step includes implementing a network initiated implicit secondary packet data procedure which is used by said first device and said first core network to reserve the radio resources they will use to establish the media flow with said second device.

4. The method of claim 3, wherein said network initiated implicit secondary packet data procedure enables said first device and said first core network to reserve the radio resources by allowing each of them to locally create/activate a packet data protocol context in a manner that reduces and possibly eliminates session management signaling over an air-interface between said first device and said first core network.

5. The method of claim 4, wherein if said first device and said first core network operate in an A/Gb-mode then the session management signaling is reduced when:
said core network copies parameters from a previously activated packet data protocol context and uses context information parameters to locally activate its packet data protocol context, wherein said context information parameters have been:
(a) piggy-backed in application level signaling which is received from said device;
(b) pre-defined within a standard; or
(c) mixed piggy-backed/pre-defined; and
said device receives a transaction identifier sent within session management signaling from said core network and uses the transaction identifier to identify which context to activate locally.

6. The method of claim 4, wherein if said first device and said first core network operate in an Iu-mode then the session management signaling is eliminated when:
said core network copies parameters from a previously activated context and uses context information parameters to locally activate its context, wherein said context information parameters have been:
(a) piggy-backed in application level signaling which is received from said device;
(b) pre-defined within a standard; or
(c) mixed piggy-backed/pre-defined; and
said device receives a radio bearer identity value via bearer level signaling from a radio access network and uses the radio bearer identity value which corresponds to a network service access point identifier value to identify which context to activate locally.

7. The method of claim 1, wherein:
said first device is a general packet radio service user equipment and said second device is a general packet radio service user equipment;
said first device is a general packet radio service user equipment and said second device is a server; or
said first device is a general packet radio service user equipment and said second device is a wireless local area network user equipment.

8. A device comprising:
a processor that enables a media flow to be established with a remote device by performing the following actions:
send, towards said remote device, a first message which indicates that the radio resources which includes a set of possible codecs for a particular media component have been reserved so the media flow could be established with said remote device;
receive, from said remote device, a second message which indicates that said remote device has reserved radio resources including one of the possible codecs for the particular media component that it needs to establish the media flow; and
after receiving the second message, reserve the radio resources that will be used to establish the media flow with said remote device.

9. The device of claim 8, wherein said processor reserves the radio resources used to establish the media flow with said remote device by taking part in a network initiated secondary packet data protocol context activation procedure.

10. The device of claim 8, wherein said processor reserves the radio resources used to establish the media flow with said remote device by taking part in a network initiated implicit secondary packet data procedure.

11. A method for establishing a media flow between a first device and a second device, said method comprising the steps of:
sending, from said first device, a first message towards said second device, wherein the first message includes:
a session description protocol offer which contains a set of possible codecs for a particular media component anyone of which could be used to establish the media flow with said second device;
a media active indication; and
a service indication;
receiving, at said first device, a second message initiated by said second device, wherein the second message includes:
a session description protocol answer containing a codec selected from the set of possible codecs for the particular media component that will be used to establish the media flow with said first device;
a media active indication; and
a service indication;
reserving, at said first device and a first core network, radio resources used to establish the media flow with said second device; and
sending, from said first device, a third message towards said second device, wherein said third message includes:
an acknowledgment of a receipt of the second message.

12. The method of claim 11, wherein said first device and said first core network reserves the radio resources used to establish the media flow with said second device by taking part in a network initiated secondary packet data protocol context activation procedure.

13. The method of claim 11, wherein said first device and said first core network reserves the radio resources used to establish the media flow with said second device by taking part in a network initiated implicit secondary packet data procedure.

14. The method of claim 13, wherein said network initiated implicit secondary packet data procedure enables said first device and said first core network to reserve the radio resources by allowing each of them to locally create/activate a context in a manner that reduces and possibly eliminates session management signaling over an air-interface between said first device and said first core network.

15. The method of claim 14, wherein if said first device and said first core network operate in an A/Gb-mode then the session management signaling is reduced when:
said core network copies parameters from a previously activated context and uses context information parameters to locally activate its context, wherein said context information parameters have been:
(a) piggy-backed in application level signaling which is received from said device;
(b) pre-defined within a standard; or
(c) mixed piggy-backed/pre-defined; and
said device receives a transaction identifier sent within session management signaling from said core network and uses the transaction identifier to identify which context to activate locally.

16. The method of claim 14, wherein if said first device and said first core network operate in an Iu-mode then the session management signaling is eliminated when:
said core network copies parameters from a previously activated context and uses context information parameters to locally activate its context, wherein said context information parameters have been:
(a) piggy-backed in application level signaling which is received from said device;
(b) pre-defined with a standard; or
(c) mixed piggy-backed/pre-defined; and
said device receives a radio bearer identity value via bearer level signaling from a radio access network and uses the radio bearer identity value which corresponds to a network service access point identifier value to identify which context to activate locally.

17. The method of claim 12, wherein:
said first device is informed that a network supports the network initiated secondary packet data protocol context activation procedure; and
said network is informed that said first device supports the network initiated secondary packet data protocol context activation procedure.

18. The method of claim 13, wherein:
said first device is informed that a network supports the network initiated implicit secondary packet data procedure; and
said network is informed that said first device supports the network initiated implicit secondary packet data procedure.

19. The method of claim 11, wherein said media flow includes:
a voice over IMS communication;
a video telephony;
a video-on-demand communication; or
a service identified by said service indication in said first message.

20. The method of claim 11, wherein:
said first device is a general packet radio service user equipment and said second device is a general packet radio service user equipment;
said first device is a general packet radio service user equipment and said second device is a server; or
said first device is a general packet radio service user equipment and said second device is a wireless local area network user equipment.
